(19) United States
(12) Patent Application Publication
(10) Pub. No.: US 2015/0115609 A1
(43) Pub. Date: Apr. 30, 2015

(54) METHOD FOR CONFIGURING A WIND ENERGY INSTALLATION, AND WIND ENERGY INSTALLATION

(71) Applicant: Wobben Properties GmbH, Aurich (DE)

(72) Inventors: Werner Hinrich Bohlen, Emden (DE); Helge Giertz, Leer (DE); Martin Schellschmidt, Sudbrookmerland (DE)

(21) Appl. No.: 14/386,253

(22) PCT Filed: Mar. 15, 2013
(86) PCT No.: PCT/EP2013/055353

§ 371 Date: Sep. 18, 2014

(30) Foreign Application Priority Data
Mar. 20, 2012 (DE) 10 2012 204 446.9

(51) Int. Cl. F03D 7/00; F03D 9/00

(52) U.S. Cl. CPC F03D 7/00; F03D 9/002; F03D 9/003
USPC 290/44

(57) ABSTRACT

The invention relates to a method for configuring a wind energy installation, comprising the following steps: predetermined parameters associated with the wind energy installation are selected from a control database for the purpose of configuring the wind energy installation, the selected parameters are stored on a mobile data storage medium, the selected parameters are transmitted from the mobile data storage medium to the wind energy installation, the selected parameters are implemented in the wind energy installation, the parameters implemented in the wind energy installation are read out by a monitoring device networked to the wind energy installation and to the control database, and the parameters which have been read out are compared with the predetermined parameters associated with the wind energy installation and stored in the control database.

### BACKGROUND

1. Technical Field

The present invention relates to a method for configuring a wind energy installation. The present invention also relates to a wind energy installation prepared for such configuration. In addition, the present invention relates to a wind energy installation arrangement having a wind energy installation and a control database.

2. Description of the Related Art

Wind energy installations are generally known, and one example of a wind energy installation is diagrammatically shown in FIG. 1. Wind energy installations convert energy from the wind into electrical energy and feed the latter into an electrical supply network. A wind energy installation and the entire conversion process from the wind to the electrical energy fed in have become very complex in the meantime. A multiplicity of parameters which in some cases have to be individually adjusted and possibly also changed may be provided for carrying out said process.

As the functionality of the wind energy installation increases, the number of adjustable parameters also increases. Many of these parameters are also relevant to contracts, in particular contracts with the operator of the electrical supply network into which the energy is fed. Network types, namely types of the supply network into which the energy is fed, environmental conditions and location factors make location-dependent parameterization necessary and in some cases essential for optimum operation and, in particular, also stable operation of the wind energy installation. Added to this are parameterization operations which relate to the specific type of wind energy installation used. In addition to such location-dependent parameters and parameters dependent on the type of wind energy installation, which relate to or take into account the specific installation type, the output power and tower parameters, network parameters are also particularly important, namely parameters relating to the specific feeding of energy into the electrical supply network.

All of these parameters need to be manually input by the service personnel during an activation process at different locations in the wind energy installation, for example on a display of a control cabinet or else directly on a control board with the aid of a corresponding computer. The number of such parameters to be entered during the activation process may amount to approximately 250 parameters, for example.

It is problematic, in particular, if incorrectly adjusted parameters, that is to say incorrect parameter values, are input in this case. Depending on the parameter and depending on the incorrect value, this may even result, for example, in the wind energy installation not behaving in the manner intended by the network operator in network-critical situations when feeding energy into the supply network. In particular, a network operator, who is often also an energy supplier, may have calculated error scenarios in models which take into account particular behaviors of the suppliers and consumers in the network. In this case, a particular behavior of the wind energy installation may also be taken into account and the situation in which the wind energy installation behaves in a manner other than that taken as a basis in the model calculations in a critical network situation should absolutely be avoided. Particularly in areas of high wind energy densities, such misbehavior could endanger the system stability and could result in extreme network situations, namely possibly even a so-called blackout which should be absolutely avoided.

In order to avoid such incorrect programming, such activation is carried out, in principle, only by reliable service personnel. In addition, the parameters which have been input may be checked by a second service colleague in each case. Plausibility tests are additionally possible which can detect, in particular, sign errors or incorrectly placed decimal points and thus errors in the order of magnitude. In addition, the respective process for which the parameters have been input may be simulated or tested. In addition, as many parameters as possible may be preset so that as little as possible has to be changed during activation.

However, all of these safety precautions also ultimately result only in the risk of incorrect programming being minimized. It cannot be completely excluded thereby, however. There is therefore still the risk of incorrect parameters being input, the incorrect input of which is not detected or is detected only too late.

The German Trade Mark Office researched the following prior art in the priority application: DE 10 2005 049 483 A1, GB 2 384 332 A, US 2010/0135788 A1, US 2011/0166717 A1, EP 1 045 600 A1 and W098/37661A1.

### BRIEF SUMMARY

One or more embodiments are directed to a method of configuring a wind energy installation. An embodiment is directed to a method which may exclude the input of incorrect parameters, or at least minimizes the risk of incorrect parameters

One embodiment is directed to a method for configuring a wind energy installation, which method concerns, in particular, activation of the wind energy installation. In this case, the wind energy installation contains incomplete parameters or parameters which have not been adapted and which need to be adjusted in order to thereby configure the wind energy installation. Nevertheless, the configuration can also be carried out again, however, if the installation was or is already operating, in order to make changes.

According to the proposed method, predetermined parameters are selected from a control database for the purpose of configuring the wind energy installation. These parameters are associated with the wind energy installation, namely both with the wind energy installation according to the type and with the specific wind energy installation. These parameters are therefore selected, in particular, in such a manner that the control database is informed of an identification of the specific wind energy installation, in particular according to the type and site, that is to say these data are stated and corresponding parameters associated with this identification are already stored in the control database. Finally, these parameters for the respective wind energy installations, that is to say in particular according to the type and site, are prepared by developers and project collaborators of the wind energy installation and are adapted to the specific situation. Geographical aspects, such as winds to be expected and air densities and the temperature, may be taken into account, in particular. Furthermore, it is possible to take into account specifications associated with the network connection point of the site, namely the network connection point at which the relevant wind energy installation is intended to be connected to the electrical supply network for the purpose of feeding in energy.

The parameters which have been selected in this manner are then stored on a mobile data storage medium. This may be, for example, a memory card, a USB stick, an optical data storage medium or the like.

The selected parameters are then transmitted from the mobile data storage medium to the wind energy installation. For this purpose, the mobile data storage medium, in particular, is accordingly connected to the wind energy installation, in particular is introduced or inserted into a slot provided for this purpose on the wind energy installation. For example, the wind energy installation is equipped with a computer terminal having a monitor, an input keyboard or the like and a card reader, for example. The service employee can then select, on this device, for the parameters on the mobile data storage medium, which is in the form of a memory card here for example, to be transmitted to the wind energy installation. For this purpose, this input terminal can accept all data from the mobile data storage medium and can distribute said data to the corresponding components of the wind energy installation. Another possibility involves the wind energy installation having a plurality of such devices or similar devices for loading data and involves accordingly selected data being transmitted. For example, parameters which are relevant to feeding energy into the electrical supply network may be input on a control cabinet of a corresponding inverter prepared for the feeding in of energy. Other data may be transmitted to a pod of the wind energy installation and may be transmitted there to a process computer. Such data may relate, for example, to the control of the generator of the wind energy installation or to parameters for settings for protecting against ice formation, to name but a few examples.

After the parameters have been implemented in the wind energy installation, they are read out by a monitoring device networked to the wind energy installation and to the control database. Such a monitoring device may be so-called SCADA or may use SCADA, for example. SCADA is also an abbreviation which is customary in German-speaking countries for experts in the field of wind energy installations. This abbreviation SCADA stands for “Supervisory Control And Data Acquisition”. However, in the field of wind energy installations, the term SCADA is understood more in the sense of networked observation of wind energy installations. In principle, data may also be written to a wind energy installation via SCADA. However, this operation is unusual. In particular, it is unusual to control wind energy installations online using SCADA.

It is proposed here to only read out the parameters which have been implemented using the mobile data storage medium. In a further step, these parameters which have been read out are then compared with the predetermined parameters associated with the wind energy installation and stored in the control database. Provision is therefore made for the parameters to be transmitted from the control database to the mobile data storage medium, for this mobile data storage medium to then be taken to the wind energy installation and for the stored parameters to be transmitted there in situ and to be accordingly implemented in the wind energy installation. This already avoids errors caused by individually inputting the parameters. In addition, a check is carried out in order to determine whether the implemented parameters are correct. This check is carried out using the monitoring device, in particular SCADA, by reading the parameters from the wind energy installation and comparing them with the parameters stored in the control database. If differences are determined here, a corresponding warning signal can be output and the implementation process can accordingly be repeated.

It should be noted that this operation is carried out, in particular, when activating the wind energy installation. When first activating a wind energy installation, many processes, including networked connections, are possibly not yet completely operating or at least have not yet been sufficiently tested. Accordingly, the networked connection between the wind energy installation and the control database may also not yet exist, may not yet completely exist or may not yet reliably exist. Transmitting the parameters to be implemented using the mobile data storage medium is therefore a safe solution. In addition, the fact that a service employee has to take the mobile data storage medium to the wind energy installation for this purpose is also not disruptive. Finally, service personnel must be in situ at the wind energy installation anyway during activation.

Such transmission using the mobile data storage medium, to which the parameters have previously been transmitted from the control database, is a safe variant in any case in comparison with manual parameter input. Nevertheless, a check of the parameters implemented in this manner using a networked monitoring device, in particular networked SCADA, is proposed. If the networked connection is poor or does not yet exist, the comparison can be carried out later. The installation can already be activated, at least for the purpose of testing or in sections. The worse the networked connection to the wind energy installation, the higher the probability of the wind energy installation being installed at a great distance from human settlements and at least a threat to humans is therefore low in the case of an incorrect parameter. However, a networked connection can be expected at some time and may, for the rest, be wired or use radio or a combination. The comparison can then be carried out.

As an alternative, it is proposed for the wind energy installation to be configured via the networked connection. This solution is also based on the concept of transmitting the parameters to be implemented from the control database to the wind energy installation instead of manually inputting them. In a corresponding manner, this solution also proposes selecting predetermined parameters associated with the wind energy installation from the control database for the purpose of configuring the wind energy installation. Instead of storing the selected parameters on a mobile data storage medium, a data storage medium identifier is stored on the mobile data storage medium. This data storage medium identifier is associated with the selected parameters and the wind energy installation to be configured. The mobile data storage medium is then coupled to the wind energy installation and a check is first carried out in order to determine whether the data storage medium identifier matches that of the wind energy installation. If this is the case, the selected parameters are then transmitted from the control database to the wind energy installation using the transmission device networked to the wind energy installation and to the control database, that is to say the SCADA for example, and the parameters are implemented in the wind energy installation. The mobile data storage medium hereby functions for identification purposes, thus avoiding inadvertent transmission of parameters, in particular incorrect parameters. This also implements a security aspect; this is because unauthorized access, in particular a so-called hacker attack, is therefore avoided because transmission and implementation of the data require identification at the installation in situ using the mobile data storage medium.

The two solutions described therefore propose implementing the parameters with the aid of a mobile data storage medium. In one case, the latter comprises the parameters as such and, in the other case, it comprises only an identifier which can then be used to select and transmit the corresponding parameters using the networked connection.

Each of the parameters is preferably identified by an individual parameter key and the parameter key comprises the information relating to the identification parameters, the information relating to the identification of the wind energy installation in which the parameter is used, and/or the information relating to the identification of the person who last changed the implemented parameter. The identification of the parameter prevents an incorrect parameter being inadvertently transmitted. The same applies to the identification of the wind energy installation. The identification of the person who last changed the implemented parameter can be used to better understand who has made changes. This makes it possible to check, for example, whether an authorized person has actually changed the parameter. If the parameter has not been changed in a comprehensible manner, that is to say, in particular, has been changed to an undesirable value, it is possible to confer with the person who made the change. The reason can regularly also be discerned from the person who changed the parameter. In addition, service employees regularly keep a duty book or the like in which the activities which have been carried out are written down. If problems occur, a check can also be carried out here between the changed parameter and the log in this duty book.

According to one embodiment, the parameters comprise data for controlling a generator of the wind energy installation, data for controlling the feeding of electrical energy from the wind energy installation into an electrical supply network, operation management data, and/or data for controlling protective functions of the wind energy installation. However, this is not a conclusive list. A plurality of parameters are often needed to capture such a relationship. For example, a relationship between the speed and power of the generator may be stored.

Data for controlling the feeding-in of electrical energy may contain, for example, specifications by the network operator of the electrical supply network. These include, for example, limit values at which the feeding-in must be reduced or interrupted.

Operation management data may concern, for example, the control of an aviation beacon on the wind energy installation or untwisting of lines which lead from the tower into the pod and have been twisted on account of azimuth tracking. These are also only a few examples.

Data for controlling protective functions of the wind energy installation may concern safety shutdowns, for example.

Another embodiment proposes that a change signal is transmitted from the wind energy installation to the monitoring device when at least one parameter in the wind energy installation has been changed. Such a change signal may optionally contain information for identifying the at least one changed parameter, namely, in particular, the date of the change, the time of the change, and/or the identification of the changed parameter. In this respect, additional steps are proposed if implementation of all parameters has been substantially concluded during initial activation. Parameters can either be subsequently changed or it has been found that another parameter must be adapted during activation.

Parameters of the wind energy installation and parameters stored in the control database are preferably compared only for the changed parameters, that is to say for the parameters identified by the change signal. Such a partial check is proposed, in particular, if only one parameter or a few parameters has/have been changed. If a very large number of parameters are changed, that is to say at least 10 parameters or at least 20 parameters for example, it may be useful to compare the entire parameter set. The parameters which have been read out are preferably compared with the predetermined parameters associated with the wind energy installation and stored in the control database parameter by parameter. One implemented parameter after the other is therefore read out and compared with the associated parameter stored in the control database. This has the advantage, in particular, that a comparison can nevertheless be carried out in stages in the case of a weak networked connection which enables, in particular, only slow or sporadic data transmission. If the parameters are directly transmitted from the control database to the wind energy installation using the networked monitoring device, this transmission is likewise also carried out parameter by parameter. One parameter after the other may thus be transmitted and implemented. The parameter which has been transmitted and implemented is also preferably checked for this purpose in order to be able to also exclude a transmission error.

One refinement proposes that the selected parameters in a parameter set and an identification code associated with the wind energy installation are combined or they are associated with such an identification code. It is advantageous if such an identification code is composed of at least a type code identifying the type of wind energy installation and an individual code identifying the specific wind energy installation. It is therefore possible to carry out a first identification and thus also a classification for an installation type, for example a wind energy installation of the type E82 from Enercon, to name just one example. Many parameters which are associated with such a wind energy installation according to the type are similar or identical. Furthermore, however, it may be important, at least for some parameters, where the specific wind energy installation has been installed. For example, two wind energy installations of the same type may be connected to different network connection points, however. If different rules apply to these two network connection points, these wind energy installations of the same type must nevertheless be configured differently. The use of the individual code identifying the specific wind energy installation is proposed for this purpose.

Such parameters may also be accessed, for example, by a development department. The development department may make changes, for example, for parameters of an installation type and may newly store these changes for the same installation type or a specific wind energy installation and may provide them with the corresponding changed individual code. When selecting the predetermined parameters associated with the wind energy installation, the necessary parameters can be identified using this composite code.

In one embodiment, only a few of the parameters combined in the data record are preferably implemented when implementing the parameters in the wind energy installation. This may be advantageous, in particular, in the case of subsequent changes. For example, particular parameters of an installation type may be changed on account of an improvement by the company. Such changes may then be applicable to the parameters of each installation of this type. All of these parameters can be identified and changed using the type code. These parameters are then only accordingly replaced.

It is preferably proposed that the wind energy installation is activated when the parameters changed or implemented in the wind energy installation have been compared with the predetermined parameters associated with the wind energy installation and stored in the control database. During initial activation in particular, but also in the event of subsequent changes, the parameters are preferably transmitted to the wind energy installation, whereupon a check, that is to say a comparison, with the parameters stored in the control database via the networked monitoring device is awaited. After this comparison, it is then possible to provide a release signal or another signal which informs the service employee that the newly implemented parameters are correct. If they are not correct, a corresponding warning or a corresponding indication is output. This indication may generally be a warning stating that there is an error and/or may identify specific parameters for which an error has occurred. The installation is then not activated and an error, in particular also an accident or damage, can accordingly be avoided thereby.

A wind energy installation for generating electrical energy from wind is also proposed, which installation is prepared to be configured using a method of the options or embodiments described above. In particular, such a wind energy installation has corresponding devices in order to be able to read the mobile data storage medium. Furthermore, the wind energy installation is correspondingly networked to the monitoring device. Corresponding software which enables implementation and/or comparison is also provided.

Furthermore, a wind energy installation arrangement is proposed, which arrangement also comprises, in addition to a wind energy installation, a control database and a monitoring device networked to the control database. Such a wind energy installation arrangement is prepared to be configured by a method according to one of the options or embodiments described above. Not only a wind energy installation or a plurality of wind energy installations but also the provision of a corresponding database and a networked monitoring device are therefore proposed.

### BRIEF DESCRIPTION OF THE SEVERAL VIEWS OF THE DRAWINGS

The invention is explained in more detail below by way of example using embodiments and with reference to the accompanying figures.

FIG. 1 diagrammatically shows a perspective view of a wind energy.

FIG. 2 shows a diagram for illustrating the networked connection of a wind energy installation apparatus.

FIG. 3 shows a diagram for illustrating the processing of parameters and other data in a wind energy installation arrangement.

FIG. 4 shows a diagram for illustrating the sequence of a parameter comparison in a wind energy installation or a wind farm having a plurality of wind energy installations.

### DETAILED DESCRIPTION

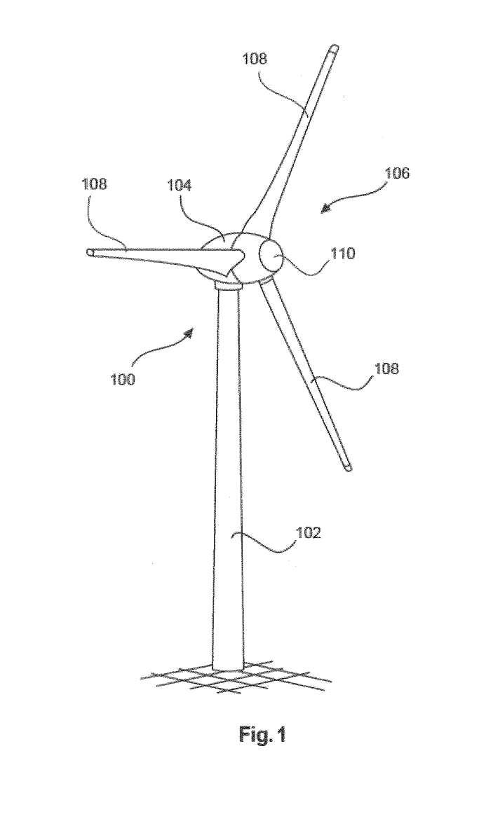

FIG. 1 shows a wind energy installation 100 having a tower 102 and a pod 104. A rotor 106 having three rotor blades 108 and a spinner 110 is arranged on the pod 104. During operation, the rotor 106 is caused to rotate by the wind and thereby drives a generator in the pod 104.

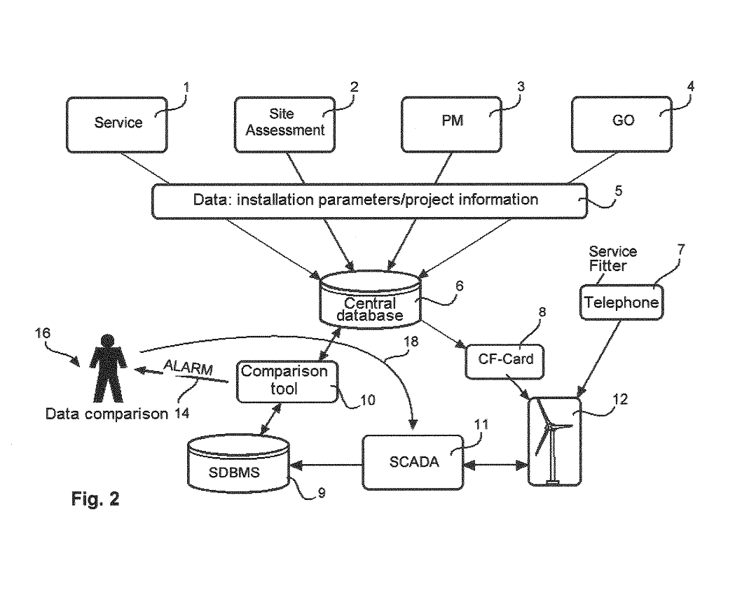

The diagram in FIG. 2 illustrates that specification data, so-called desired data, including predetermined parameters are stored in a central database 6. The central database 6 may be in the form of a so-called SAP 6. Installation parameters and project information, in particular, are stored in the central database 6. These data are at least partially needed to control the wind energy installation and the central database 6 is therefore also referred to as a control database 6.

The service 1, the site assessment 2, the department PM 3 and the department GO 4 may access the control database, which is illustrated by the data communication block 5. Access concerns the reading or writing of data, such as installation parameters and project information.

The site assessment 2 denotes site assessment of a planned site for a wind energy installation. This may comprise the assessment of the prevailing wind and weather conditions, existing network conditions and local regulations, to name but a few examples.

The PM 3 denotes project management which looks after project-specific implementation and performance of installation and set-up work when constructing a new wind energy installation or a new wind farm. The department GO 4 concerns the planning, implementation and monitoring of the connection of a wind energy installation or a wind farm to an electrical supply network.

In order to configure the wind energy installation 12, the corresponding parameters are written to or stored on a mobile data storage medium 8 and are transmitted to the wind energy installation 12 using the data storage medium 8 which has been prepared in this manner. For this purpose, a service employee takes the described mobile data storage medium 8 to the wind energy installation 12. In this case, the mobile data storage medium is provided in the form of a memory card, in particular a so-called CF card. A CF card is a memory card which uses an interface standard which is also referred to as CompactFlash.

Further access possibilities, possibly with restriction, also exist for the service or a fitter via a telephone 7. In order to check whether the parameters implemented in the wind energy installation 12 are correct, it is possible to carry out a comparison with the data in the control database 6. A networked connection which uses a SCADA system 11 is provided for this purpose. The parameters implemented and stored in the wind energy installation 12 are then compared with the aid of a comparison tool 10 via the SDBMS block 9.

The abbreviation SDBMS of the block 9 stands for SCADA Database Management System and is a database control system of the SCADA system. The block 9 therefore has the task of storing actual values of the relevant wind energy installation and providing them for comparison with the desired value in the central database. The comparison tool establishes communication with the control database 6. At the same time, the comparison tool 10 may transmit an order or an alarm 14 to a service employee 16 dealing with the data comparison.

The service employee 16 may also carry out a manual comparison using the SCADA system 11 which also enables communication with the wind energy installation 12. Such a manual comparison is possible, in particular, when individual parameters are changed. In this respect, the communication arrow 18 for manual comparison is depicted for illustration.

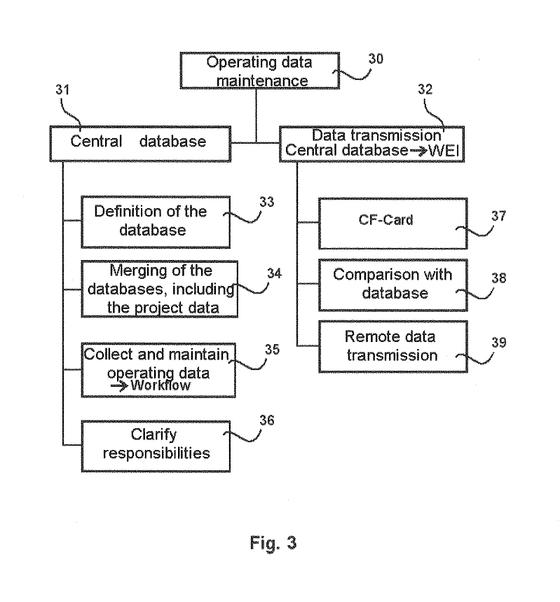

FIG. 3 illustrates an overview of the origin and use of necessary parameters of the wind energy installation. Operating data maintenance which is indicated and illustrated using the block 30 is superordinate thereto. The further blocks are also primarily used to illustrate the relationships. The control database, which is indicated in FIG. 3 as a central database 31, and the operation of transmitting data from the control database to the wind energy installation, which is illustrated by the data transmission block-central database->WEI 32, are important for the parameters.

For the sake of completeness, it is explained that a block 33 for defining the database and a block 34 for merging the databases, including the project data, belong to the central database 31. A block 35 is representative of a workflow which concerns the collection and maintenance of operating data. The clarification of responsibilities is illustrated by the block 36 and is summarized under the entire complex of the control database.

The memory card block 37 is indicated as an element of the data transmission from the control database to the wind energy installation according to block 32. This block 37 is intended to illustrate, in particular, the process of transmitting data from the memory card 8 to the wind energy installation 12 according to FIG. 2 as part of the data transmission according to block 32. The comparison block 38 illustrates the process of comparison with the database and comparison with the control database. It concerns, in particular, the operations described with respect to FIG. 2 in connection with the SDBMS block 9 and the comparison tool 10. Another important point is remote data transmission, for which the remote data transmission block 39 is depicted as a representative. The remote data transmission block 39 illustrates the remote data transmission process and in this case refers to the description of the SCADA block 11 in FIG. 2.

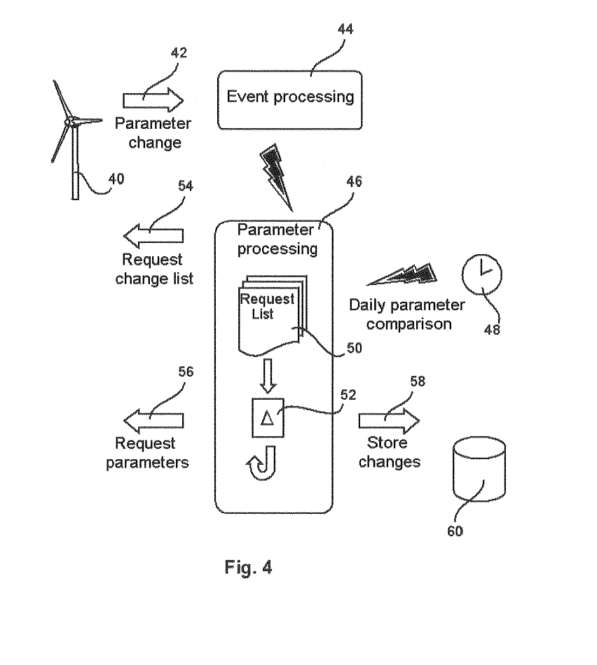

FIG. 4 illustrates processes of comparing parameters with the aid of SCADA in a somewhat more detailed manner. The process first starts from a wind energy installation 40 which emits a parameter change message 42 to an event processing means 44. This event processing means 44 processes the message 42 relating to the parameter change and thus affects the parameter processing in the parameter processing block 46. In addition or as an alternative, temporal control, in particular temporal triggering, of a parameter comparison according to the time controller 48 has an effect.

A request list 50 is then created in the parameter processing block 46. This list is passed to a processing block 52 which coordinates further steps or forms a basis for further steps. A change list request 54 and a parameter request 56 are issued on the basis thereof, in particular. This triggers the comparison of the parameters in the wind energy installation with parameters in the control database. In a corresponding manner, which is not illustrated in the diagram in FIG. 4, these requests are satisfied and the parameters and/or change lists are provided for comparison. In this case, a comparison can be carried out using a change list or a comparison can be carried out parameter by parameter. Alternatively, both types of comparison can supplement one another or can be carried out at the same time. Furthermore, the changes made are stored in a memory 60 according to a change storage instruction 58.

A process which monitors the parameters is therefore implemented in a SCADA server system. The wind farm SCADA system and the individual installation can be compared in two different ways which can also both be carried out. It is first of all assumed that a wind farm SCADA system, that is to say a system which enables and carries out a wind farm networked connection, is present. This may mean that a wind farm having such a system is present or that only such a system is used, in particular to implement remote data transmission in a manner tailored to one or more wind energy installations.

The comparison can therefore be carried out in a temporal manner, which is illustrated by the time controller 48. In this case, the comparison is carried out once a day, for example. Changes which have occurred in the meantime, that is to say have occurred, in particular, within the last day, are detected and checked in this case.

The other method which, as stated, can also be additionally used operates in an event-controlled manner. In this case, the wind energy installation uses an event processing means, symbolized by block 44, to signal to the wind farm SCADA system that one or more parameters have changed. The parameter keys of the changed parameters and a time identification, which can also be called a time stamp, of the last change are then requested by the SCADA system. The changed parameters, that is to say changed installation parameters, are then finally read out by the wind farm SCADA system using an accordingly associated user number of the relevant service engineer. The comparison can therefore be carried out and completed.

A solution which is intended to achieve quality assurance for wind energy installations is therefore proposed. One objective to be aimed for is for each wind energy installation, to which the proposed solution is applied, to be operated with correct parameters. This is intended to be ensured.

In this case, operating parameters are entered centrally into a control database, in particular into the central database system of the wind energy installation manufacturer, and are managed therein. The central database system may also be synonymously referred to as a central database. Securely exporting the parameters of a wind energy installation, that is to say the parameters intended for a particular wind energy installation, to a CF memory card makes it possible for these parameters to be transmitted to the respective wind energy installation, which is also referred to as loading.

In order to detect differences between the parameters of the wind energy installation and the parameters in the central database system, the individual installation parameters are recorded by the installed SCADA systems in the wind farms. The parameters are then centrally compared with the parameters stored in the central database system once a day or following the occurrence of an event. In the case of differences, an item of information is then forwarded to the service.

An important aspect is a unique identification of the parameters. A unique parameter number which is also referred to as a parameter key is provided for this purpose. This number is known in the wind energy installation, which is also referred to as an installation for the purpose of simplification, and is known in the SCADA system and in the central database system and defines the parameter value using a parameter description. In this case, the parameter description contains values of the characterization of the parameter and its content. The parameter description may contain one, a plurality of or all of the following elements. It preferably contains all of the following elements:
A parameter key which is a unique key for identifying the parameter.
A valid installation identifier which identifies which installation the parameter is associated with.
A short name of the parameter.
A parameter description which is preferably in two languages, namely German and English.
The statement of the data type, namely whether a so-called long INTEGER or a so-called long WORD is used, a WORD being twice as long as an INTEGER.
A value scale and/or a value offset.
A minimum value and a maximum value.
The type of representation of the parameter value, namely whether it is decimal, hexadecimal, binary or the like. A representation key may be provided for this purpose.
A unit, in particular a physical unit.
A so-called default value, that is to say a value which is included as standard before an actually individualized value is entered.
A parameter which allocates rights to read and write and is valid throughout the system.
A level for reading rights which indicates who has reading rights.
A level for writing rights which indicates who has writing rights.
A parameter discontinuation which namely reserves parameters as place-holders.

The parameters of a wind energy installation are read out under the control of the SCADA system. In this case, each parameter is individually requested from the wind energy installation by specifying the unique parameter key. The wind energy installation responds with data content containing the parameter key, a value and a user number identifying the user who changed the parameter. If a parameter is requested which does not exist in the wind energy installation, the wind energy installation responds with a parameter key having the content “error” and with an error code which is entered where the value of the parameter would otherwise be entered.

The wind energy installation can use a status data record to signal a change of parameters to the SCADA system, as illustrated by the parameter change message 42 and the event processing block 44 in FIG. 4. The parameter keys of the changed parameters can then be read from the installations by means of a further data record having the following appearance:
Date of the last parameter change.
Time of the last parameter change.
Number of parameter keys which have changed since the last query.

If a plurality of parameters in excess of those which can be communicated using the data record have changed, a request to compare all parameters of the installation can also be made by setting a corresponding parameter key.

The date and time of the last parameter change of a wind energy installation can be used to optimize the temporal parameter request in such a manner that only wind energy installations whose time stamp differs from the time stamp stored in the SCADA system are requested. If a time comparison is thus initiated daily, only a time comparison is carried out on the respective current day for the wind energy installations which have not already been compared in another manner on that day.

A permanently predefined parameter organization which is used in the control database and also in the networked monitoring device, in particular in the SCADA system, is preferably used. In this case, parameters are preferably managed in an installation-identifier-oriented manner. Each installation type is managed separately. A definition which is effected using configuration files in which the respective parameters of the installation type are defined is used as a basis for this purpose.

In this case, each parameter of an installation is managed using its change status. This change status comprises, in particular, the current parameter value, date and time of the change, the user number of the user who made the change and possibly an error value or an error identifier. A database file for the current parameter state for each type of wind energy installation and a database file containing only the changes to all installations are preferably kept. Two database files are therefore provided for each installation type and the data field descriptions of these database files preferably have an identical structure. They contain the date and time of the last change, the specific installation number, the installation type which is stored only in the change file, however, an error code which may be a numerical value consisting of three characters, a parameter key which may be an integer value with five characters, a parameter, that is to say a parameter value, which may be constructed as a double value with 10 characters and two decimal places, and the user of the last parameter change for whom a string having 20 characters may be provided, that is to say a data field which in principle can hold any desired characters, in particular numbers and letters.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for configuring a wind energy installation, the method comprising:
selecting predetermined parameters associated with the wind energy installation from a control database for the purpose of configuring the wind energy installation;
storing the selected parameters on a mobile data storage medium;
transmitting the selected parameters from the mobile data storage medium to the wind energy installation;
implementing the selected parameters in the wind energy installation;
retrieving the implemented parameters using a monitoring device networked to the wind energy installation and to the control database; and
comparing the implemented parameters with the predetermined parameters associated with the wind energy installation and stored in the control database.

2. A method for configuring a wind energy installation, the method comprising:
selecting predetermined parameters associated with the wind energy installation from a control database for the purpose of configuring the wind energy installation;
storing a data storage medium identifier associated with the selected parameters and with the wind energy installation to be configured on a mobile data storage medium;
coupling the mobile data storage medium to the wind energy installation;
comparing a data storage medium identifier with an identifier of the wind energy installation;
when the data storage medium identifier corresponds to the identifier of the wind energy installation, transmitting the selected parameters from the control database to the wind energy installation using a monitoring device networked to the wind energy installation and to the control database; and
implementing the selected parameters in the wind energy installation.

3. The method according to claim 1, wherein each parameter is identified by an individual parameter key and the parameter key comprises at least one of the following items of information:
identification of the parameter,
identification of the wind energy installation for associated with, and
identification of a person who last changed the implemented parameter.

4. The method according to claim 1, wherein the parameters comprise at least one of the following:
data for controlling a generator of the wind energy installation,
data for controlling the feeding of electrical energy from the wind energy installation into an electrical supply network,
operation management data, and
data for controlling protective functions of the wind energy installation.

5. The method according to claim 1 further comprising transmitting a change signal from the wind energy installation to the monitoring device when at least one parameter in the wind energy installation has been changed.

6. The method according to claim 5, wherein comparing the implemented parameters with the predetermined parameters comprises comparing only the changed parameters identified by the change signal with the predetermined parameters associated with the wind energy installation and stored in the control database.

7. The method according to claim 1 wherein:
retrieving the implemented parameters comprises retrieving each implemented parameter individually from the wind energy installation; and
comparing the implemented parameters with the predetermined parameters comprises comparing each individually retrieved implemented parameter with the corresponding parameter stored in the control database.

8. The method according to claim 1, wherein selecting parameters comprises selecting parameters in a parameter set that are combined based an identification code associated with the wind energy installation or are each associated with the identification code, and the identification code including at least one of:
a type code identifying the type of wind energy installation; and
an individual code identifying the specific wind energy installation.

9. The method according to claim 8, wherein a subset of the parameters combined are implemented in the wind energy installation when implementing the selected parameters in the wind energy installation.

10. The method according to claim 1, wherein after comparing the implemented parameters with predetermined parameters associated with the wind energy installation, activating the wind power installation.

11. A wind energy installation for generating electrical energy from wind, wherein the wind energy installation is configured according to the method of claim 1.

12. A wind energy installation arrangement comprising;
a control database;
a monitoring device networked to the control database; and
a wind energy installation configured by the method according to claim 1.

13. The method of claim 5 wherein the change signal contains information for identifying the at least one changed parameter and at least one of the following:
date of the change;
time of the change; and
identification of the parameter changed.

14. The method of claim 5 wherein all of the implemented parameters are compared when an amount of changed parameters exceeds a threshold amount.

15. The method of claim 2, wherein each parameter is identified by an individual parameter key and the parameter key comprises at least one of:
identification of the parameter;
identification of the wind energy installation for associated with; and
identification of a person who last changed the implemented parameter.
